(19) United States
(12) Patent Application Publication
(10) Pub. No.: US 2004/0262869 A1
(43) Pub. Date: Dec. 30, 2004

(54) Ergonomically designed knee dolly for use in all work tasks/applications which require one to perform various tasks on their knees

(76) Inventor: Nick R. Reining, Wasilla, AL (US)

Correspondence Address: Nick Reining, P.O. Box 298535, Wasilla, AK, 99629, US

(21) Appl. No.: 10/779,208

(22) Filed: Jul. 10, 2004

Related U.S. Application Data
(60) Provisional application No. 60/451,806, filed on Mar. 3, 2003.

(51) Int. Cl. B62B 1/00

(52) U.S. Cl. 280/79.11

(57) ABSTRACT

An ergonomically designed and improved invention which relates to the field of kneeling devices, more particularly, relates to an improved kneeling apparatus that provides a lower kneeling position as well as pre-formed knee cups that put your knees to within one-half inch of the floor providing for less back strain and the ability to serve the worker with added material hauling capabilities and task related tool holders.

The apparatus is comprised of a hardwood or solid plastic frame with two knee shaped cups formed/molded into the flat surface of the knee dolly protruding downward to 1/2″ of the floor. No other mobile knee device puts the knees closer to the floor, thereby minimizing back strain. Six casters provide support an ease of mobility by the user. The knee cups are designed to be large enough to also accomodate knee pads if worker desires. The flat surface of our product also provides for material handling and furniture moving, up to 300 lbs.

### CROSS REFERENCE TO RELATED ITEMS

Not Applicable

1. Field of Invention

The present invention generally relates to the field of kneeling devices, more particularly, relates to an improved kneeling apparatus that provides a lower kneeling position as well as pre-formed knee cups and the ability to serve the worker with added material hauling capabilities and task related tool holders.

2. Background of the Invention

Workers, such as flooring installers, shelf stockers, cove base installers are often required to perform these tasks from a kneeling position, while maintaining balance and the need for mobility. Workers are often required to continually get up and down to retrieve work related tools or supplies to complete tasks, losing valuable work time and increasing the stress and strain on their back and knees. No previous invention offered ergonomic design to “fit the knee” of the user making lateral movement easier and lowering the knees closer the floor, providing for less back strain.

A number of kneeling apparatus have been proposed over the years in an effort to alleviate the stress and fatigue associated with the kneeling position of a worker.

Among those is U.S. Pat. No. 6,302,413, B1 to Comeau for a knee cart with a seat. This knee cart has the worker on his knees too far from the floor, creating too much stress on the back. This device also lacks the stability of our proposed invention and its multiple functionality, and recessed cups for the knees, which will accommodate workers who choose to wear knee pads for additional support and comfort at the same time.

Another kneeling apparatus is that shown in U.S. Pat. No. Des. 317,833 to Miller et al. The Miller et al. patent disclosed an ornamental design for a kneeling device having a rectangular knee pads for supporting a workers knees and vertically positioned combination handles and tool boxes.

Still another device is that shown in U.S. Pat. No. 5,380,021 to Doherty for a mobile knee support apparatus. The Doherty apparatus discloses a pair of horseshoe shaped frames supported on casters. A sling of sheet material is spread on each frame for supporting the knees. The frames are connected by a flexible connector or a rigid sheet.

Still another device is U.S. Pat. No. Des. 330,957 for a combined creeper and tool caddy. The design discloses a wheeled creeper having knee supports. Another kneeling device is that shown in U.S. Pat. No. 3,863,978 to Gillings, Jr. for a body supporting structure for supporting the user in a combined kneeling and sitting position.

None of these devices provide ergonomic design to “fit the knee” of the user, allowing them to be closer to the floor and their work. Additionally our invention allows the worker to leave his knee pads on if they chose to. None of these devices provide for multi-purpose tasking such as using the device to move heavy objects i.e., carpet rolls, heavy boxes or refrigerators, all of which minimize the risk of injury. Finally, with our recessed knee cup design the workers knees can more easily “grip” the apparatus with their knees for more control and stability and by virtue of their knees being only one half inch off the floor have better balance and less strain on their backs. Task related work items can also be stored on the device. These are foremost considerations of our invention. Considering the foregoing, a need exists for an improved kneeling apparatus with knees sitting closer to the floor, with the ability for the worker to also wear knee pads if desired and the ability for this apparatus to serve other work related tasks for the worker, such as hauling heavy objects.

### SUMMARY OF INVENTION

The applicants improved kneeling apparatus is designed to satisfy the aforementioned needs. The apparatus consists of an oak or similar strength frame with two pre-formed knee cups, recessed on the apparatus to sit within one half inch of the floor. Supported by six casters for strength and multi-purpose functions. Each knee cup has padded shell liners in them for added comfort and is large enough to accommodate a worker who also needs to wear knee pads while kneeling on this apparatus. By providing a lower nested knee position the worker is required to bend over less distance, has greater control over the device and the six wheels provide for a load of over 300 lbs and easier turning capability. The apparatus is light, easily stored and carried. The padded knee shells are spaced enough to accommodate additional knee pads if desired and the placement of the wheels provide for excellent non-tipping characteristics. In the preferred embodiment the frame is rectangular and made of four pieces of oak for strength though other frame configurations, even a solid polyethylene extruded frame might be utilized. Strong polyethylene cups comprised the knee holders and when attached to the oak frame provide for additional strength rigidity of the apparatus.

In the preferred embodiment, the frame is support by six metal frame casters, each having hard plastic wheels which have less scarring properties on floors The wheels are mounted below the frame and between the knee cups perpendicular to the center of gravity of the worker to support the body weight and provided for ease of turning.

The preferred embodiment employees a pair of rigid, hard plastic shells that are recessed to sit one half inch from the floor. The knee supports have a layer or layers of padding for cushioning the workers knees. The plastic shells have been made large enough to accommodate a worker who also may be wearing conventional knee pads.

It is therefore an object of this invention to provide a lower kneeling position for the worker and the apparatus, by design, encompasses the workers knees rather than the knees sitting on top of the apparatus thus providing for easier mobility and less tipping action when mobility is required and less strain on the back

It is a further object of the invention to provide multi-purpose utility for moving heavy objects related to the workers trade or homeowners. The six wheels are attached to the oak at intersecting points of the parts of the wood for added strength and stability. It is still further the object of this invention to provided the worker with an area to lay tools and particulars of the workers tasks, thus requiring less repetitious ups and downs by the worker

### BRIEF DESCRIPTION OF THE DRAWINGS

FIG. 1 is an isometric view of the kneeling apparatus, of the present invention

FIG. 2 is a front view of the kneeling apparatus of FIG. 1.

FIG. 3 is the rear view of the kneeling apparatus of FIG. 1.

FIG. 4 is a side view of the kneeling apparatus of FIG. 1.

FIG. 5 is a bottom view of the Kneeling apparatus of FIG. 1.

### DETAILED DESCRIPTION OF THE INVENTION

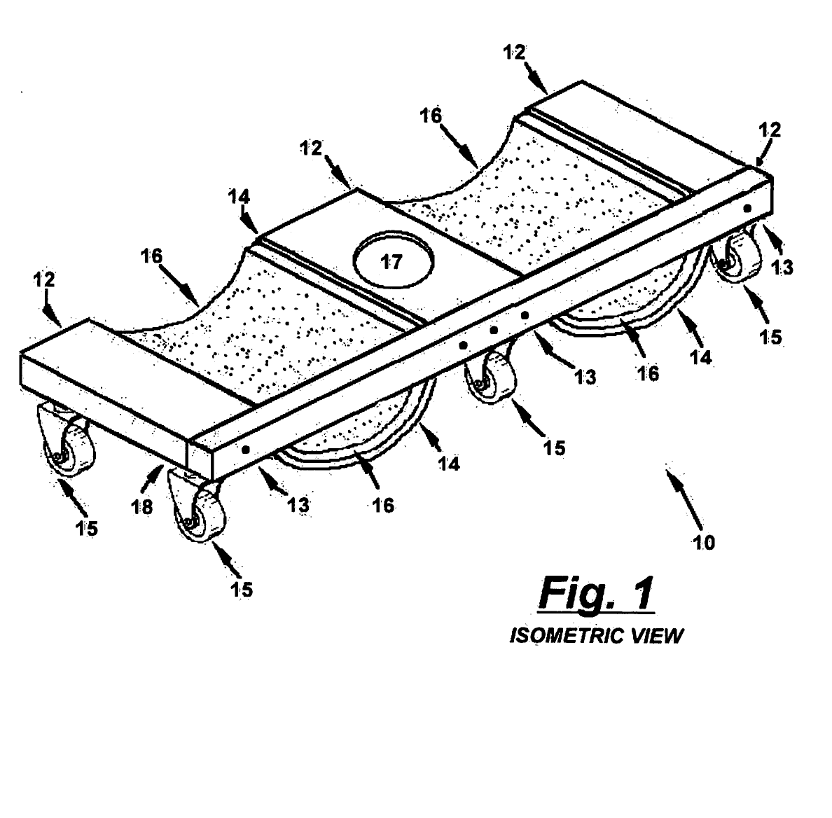

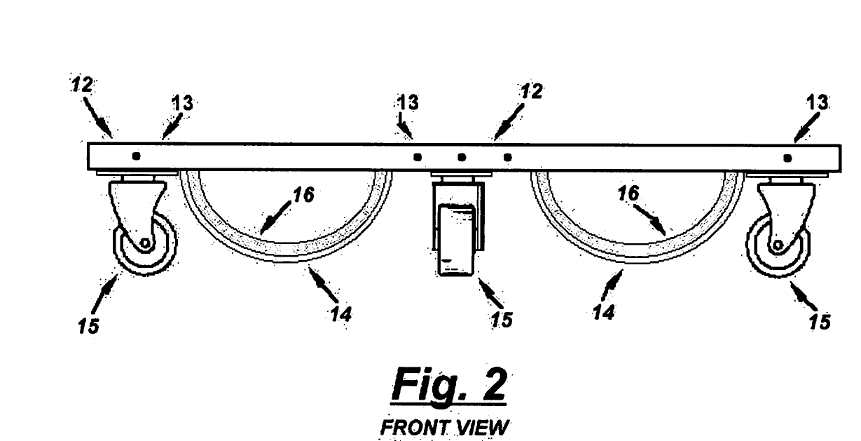

Referring now to the drawings, and more particularly to FIG 1, there is shown an isometric view of the kneeling apparatus(10) of the present invention. The apparatus (10) is comprised of a rectangular shaped hardwood frame(12). The frame(12) is made of four separate pieces of ¾″ oak, attached to each other with wood glue and screws, though other materials may could be utilized

As shown in FIG. 1 the frame is disposed in a horizontal plane. Comprised of four separate pieces of oak creating the frame. Each piece of the frame(12) is attached by screws(13) and glue for strength. Edges are sanded and finished with commercial sealer.

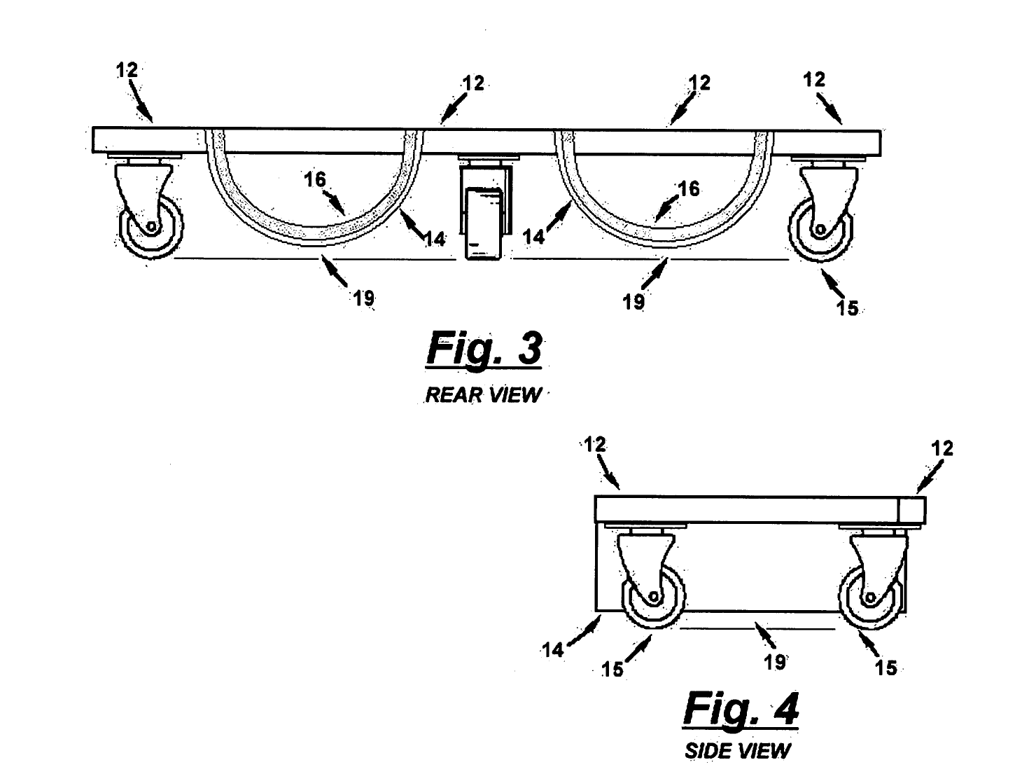

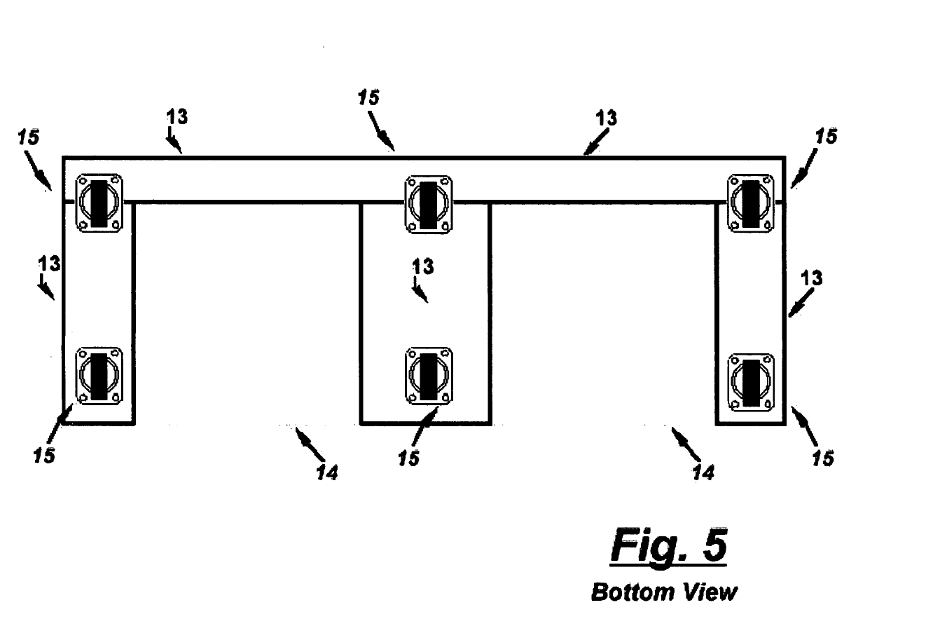

As shown in FIG. 3 the rigid plastic knee cups(14) are flush to the top of the frame(12) arching downward to one half inch of the floor(19) when wheels(15) are attached. The plastic knee cups(14) are attached to the frame(12) by screws(16) added considerably strength to the apparatus. The knee cups(14) are padded with one half inch high density foam(16) for added comfort to the worker As shown in the drawings, the frame(12) has a plurality of wheels(15). In FIG. 13 you see the number of castor wheels (15) located on each side of the frame(12). Six, hard plastic wheels(15) have been utilized to provide for less floor scarring and friction. The wheels(15) base plates have been arranged to span the splices in the frame(12) at the three applicable points(18).

In FIG. 1 you will notice a small, task specific tool area(17) located between the knee cups(14) this area will provide the worker with a space for any number of items that may help prevent them from getting up and down repetitively during a project. FIG. 4 (19) illustrates the close proximity the workers knees sit to the floor, a critical factor to consider when having to work on your knees. With the workers knees “recessed” down in the knee cups(14) apparatus, it is much easier to move it around.

It is thought that the improved kneeling apparatus of the present invention and many of its attendant advantages will be understood from the foregoing description and it will be apparent that various changes may be made in form, construction and arrangement of the parts thereof without departing from the spirit and scope of the invention or sacrificing all of its material advantages, the form described herein being merely a preferred embodiment of the invention.

I claim:

1. An apparatus offering the best possible support and mobility for anyone who must perform tasks on their knees comprised of:
(a) a rectangular hardwood frame disposed on a horizontal plane, with upper and lower surfaces, forward and rearward ends.
(b) a plurality of support casters on both bottom sides and ends of the apparatus.
(c) a pair of padded knee supports mounted to the side of the hardwood frame and arching downward into a cup shape approximately ½″ from floor.
(d) a small tool attachment is located on the frame to also serve as a handle.
(e) a strong frame and lowered knee cups allow this apparatus to be used for moving tasks such as heavy carpet rolls, vinyl or boxes saving injury

2. The apparatus recited in claim 1 wherein said knee supports are comprised of padded, hard plastic “half circle” shell, which lowers the knees to the lowest possible position next to floor.

3. The improved kneeling apparatus offers the best possible back and knee support and mobility, keeping the worker close to the floor.

4. The improved kneeling apparatus is also ideally suited for hauling heavy objects substantially rewarding the worker.

5. The improved kneeling apparatus allows the knees to sit closer to the floor putting the worker closer to his work with less effort and strain to move.

6. The improved kneeling apparatus allows the worker easier turning and moving capabilities as the knees sit down into the apparatus and not on top of it.

7. The improved kneeling apparatus by virtue of six wheels aids the worker in turning and moving over rougher surfaces.

8. The improved kneeling apparatus provides for task specific tool storage.

9. The improved kneeling apparatus uses hard plastic wheels providing for less friction, ease of turns and scuff resisting qualities.
